(19) United States
(12) Patent Application Publication
(10) Pub. No.: US 2026/0129698 A1
(43) Pub. Date: May 7, 2026

(54) ASYNCHRONOUS DATA TRANSMISSION

(71) Applicant: Charter Communications Operating, LLC, St. Louis, MO (US)

(72) Inventors: Stephen Bradley Horton, Centennial, CO (US); Stephen C. Opferman, Denver, CO (US)

(21) Appl. No.: 18/938,007

(22) Filed: Nov. 5, 2024

(51) Int. Cl. H04W 76/15; H04L 67/143; H04W 64/00

(52) U.S. Cl. CPC H04W 76/15; H04L 67/143; H04W 64/00

(57) ABSTRACT

Systems and methods for asynchronous data transmission are provided. In one example, a first computing device establishes a connection to a second computing device. The second computing device is in a first location where network connectivity is limited and/or unavailable. In some examples, the second computing device is an anchor computing device of a mesh network. The first computing device obtains a data payload from the second computing device, which includes a plurality of data packets generated by the second computing device and/or other computing devices of the mesh network. The first computing device establishes a connection to a wide area network (WAN) at a second location, which is different from the first location, and provides the data payload to a remote computing system over the WAN.

### BACKGROUND

Wireless networks, such as cellular networks (e.g., Fourth Generation (4G) networks, Fifth Generation (5G) networks, etc.) and/or Wi-Fi® networks, are operated by network service providers and are operable to provide wireless connectivity to a wide variety of computing devices, such as smartphones, tablets, Internet of Things (IoT) devices, and/or the like. To do this, network service providers deploy, operate, maintain, etc. a wide array of network infrastructure hardware, such as transceivers (e.g., cellular base stations, Wi-Fi® transceivers, distributed antenna systems (DAS), femtocell and picocell transceivers, machine-to-machine (M2M) transceivers, Internet-of-Things (IoT) transceivers, etc.), routers (e.g., gateway routers, etc.), network switches (e.g., layer 2 switches, layer 3 switches, etc.), remote computing systems (e.g., proxy servers, network-attached storage (NAS) devices, storage area network (SAN) devices, etc.), satellite communication systems, and/or the like.

### SUMMARY

The examples disclosed herein are directed to systems and methods operable to implement asynchronous data transmissions.

In one implementation, a method is provided. The method includes establishing, by a first computing device at a first location, a connection to a second computing device. The method further includes obtaining, by the first computing device from the second computing device, a data payload. The data payload includes a plurality of data packets generated by the second computing device. The method further includes establishing, by the first computing device at a second location that is different from the first location, a connection to a wide area network (WAN). The method further includes providing, by the first computing device via the WAN, the data payload to a remote computing device.

In another implementation, a collector computing device is provided. The collector computing device includes a memory. The collector computing device further includes a processor device coupled to the memory. The processor device is operable to establish, at a first location, a connection to a peripheral computing device. The processor device is further operable to obtain, from the peripheral computing device, a data payload. The data payload includes a plurality of data packets generated by the peripheral computing device. The processor device is further operable to establish, at a second location that is different from the first location, a connection to a wide area network (WAN). The processor device is further operable to provide, via the WAN, the data payload to a remote computing device.

In another implementation, a non-transitory computer-readable medium is provided. The non-transitory computer-readable medium includes executable instructions that are configured to cause a processor device of a first computing device to establish, at a first location, a connection to a second computing device. The executable instructions are further configured to cause the processor device of the first computing device to obtain, from the second computing device, a data payload. The data payload includes a plurality of data packets generated by the second computing device. The executable instructions are further configured to cause the processor device of the first computing device to establish, at a second location that is different from the first location, a connection to a wide area network (WAN). The executable instructions are further configured to cause the processor device of the first computing device to provide, via the WAN, the data payload to a remote computing device.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment suitable for asynchronous data transmission according to some implementations;

FIG. 2 is an illustrative example of asynchronous data transmission according to some implementations;

FIG. 3A–3D are sequence diagrams illustrating messages communicated between and actions taken by certain components illustrated in FIG. 1 to perform asynchronous data transmission operations according to some implementations;

FIG. 4A–4B are flowcharts of a method for implementing asynchronous data transmission operations according to some implementations;

FIG. 5 is a flowchart of a method for implementing asynchronous data transmission operations according to some implementations;

FIG. 6 is a flowchart of a method for implementing asynchronous data transmission operations according to some implementations;

FIG. 7 is a block diagram of a collector computing device suitable for implementing examples disclosed herein; and

FIG. 8 is a block diagram of a peripheral computing device suitable for implementing examples disclosed herein.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Wireless networks, such as cellular networks (e.g., Fourth Generation (4G) networks, Fifth Generation (5G) networks, etc.) and/or Wi-Fi® networks, are operated by network service providers and are operable to provide wireless connectivity to a wide variety of computing devices, such as smartphones, tablets, Internet of Things (IoT) devices, and/or the like. To do this, network service providers deploy, operate, maintain, etc. a wide array of network infrastructure hardware, such as transceivers (e.g., cellular base stations, Wi-Fi® transceivers, distributed antenna systems (DAS), femtocell and picocell transceivers, machine-to-machine (M2M) transceivers, Internet-of-Things (IoT) transceivers, etc.), routers (e.g., gateway routers, etc.), network switches (e.g., layer 2 switches, layer 3 switches, etc.), remote computing systems (e.g., proxy servers, network-attached storage (NAS) devices, storage area network (SAN) devices, etc.), satellite communication systems, and/or the like.

Although abundant, data connectivity and/or network connectivity is not ubiquitous. For instance, network connectivity is oftentimes limited and/or unavailable in rural environments, particularly in rural environments where the needs and/or uses of such network connectivity are outweighed by the costs associated with deploying, operating, maintaining, etc. the necessary network infrastructure hardware. However, even in areas where network connectivity and/or data connectivity is limited and/or nonexistent, there is significant vehicular presence—both public (e.g., first responders, waste collection, public utility vehicles, postal workers, etc.) and/or private (e.g., courier services, residents, etc.).

Accordingly, example aspects of the present disclosure are directed to systems and methods for implementing asynchronous data transmission operations that address the aforementioned network connectivity and/or data connectivity issues. Put differently, example aspects of the present disclosure provide systems and methods that leverage the significant vehicular presence in remote settings (e.g., rural environments) to facilitate data transmission between computing devices in the remote settings and remote computing systems, such as cloud databases. As one example, a collector computing device of the present disclosure may be affixed to a vehicle and, as such, may be operable to move between a first location (e.g., rural and/or remote setting) and a second location (e.g., central location).

More particularly, a collector computing device is provided that is operable to facilitate asynchronous data transmission between a plurality of peripheral computing devices and a remote computing system. As described herein, a collector computing device of the present disclosure may be configured to establish a communication link with a with both a first network (e.g., wireless personal area network (PAN)) and a second network (e.g., wide area network (WAN)). A peripheral computing device of the present disclosure may be located in a first location (e.g., rural and/or remote setting) where access to the second network (e.g., WAN) is limited and/or unavailable. As such, the peripheral computing devices of the present disclosure may only be configured to establish a communication link with the first network (e.g., wireless PAN) but may be unable to establish a communication link with the second network (e.g., WAN).

The collector computing device may be configured to establish a connection to the peripheral computing device(s) at the first (e.g., rural, remote, etc.) location via the first network (e.g., wireless PAN). The collector computing device may be further configured to obtain a data payload (e.g., data generated by the peripheral computing device(s)) via the first network (e.g., wireless PAN) and may store the obtained data until such time as the collector computing device returns to a second location where access to the second network (e.g., WAN) is available, not limited, and/or the like. Upon returning to the second location, the collector computing device may establish a connection to the second network (e.g., WAN) and may provide the data payload (e.g., obtained from the peripheral computing device(s)) to a remote computing system via the second network (e.g., WAN). Hence, the collector computing device may be operable as a proxy device for a quasi-communication link between the peripheral computing devices and the remote computing system.

It should be understood that, although discussed herein as relating to rural environments, example aspects of the present disclosure are applicable in any suitable environment where network connectivity and/or data connectivity is limited and/or unavailable.

As one non-limiting illustrative example of the asynchronous data transmission operations disclosed herein, a first computing device (e.g., collector computing device) may establish a connection to a second computing device (e.g., a peripheral computing device) at a first location. More particularly, the first computing device may be operable to establish a first communication link to the second computing device. In some examples, the first communication link may correspond to a wireless personal area network (PAN), such as a communication link having a Bluetooth Low Energy (BLE) protocol.

To establish the first communication link, the first computing device and the second computing device may complete a handshake transaction, such as any suitable handshake transaction. As one non-limiting illustrative example, the first computing device may receive an advertisement data packet from the second computing device. The first computing device may provide an acknowledgement packet to the second computing device that indicates the advertisement data packet was successfully received. Subsequently, the first computing device may establish a connection to the second computing device.

The first computing device may obtain a data payload from the second computing device via the first communication link. The data payload may include a plurality of data packets generated by the second computing device. In some examples, the second computing device may be an anchor computing device of a mesh network of a plurality of second computing devices. In such examples, the data payload may include a plurality of data packets respectively generated by at least one of the plurality of second computing devices of the mesh network. In this way, each of the second computing devices of the mesh network may be configured to provide a plurality of data packets to the first computing device via the anchor computing device (e.g., the second computing device).

More particularly, to obtain the data payload, the first computing device may receive the plurality of data packets from the second computing device. In some examples, at least one of the plurality of data packets may include data indicative of a transmission size threshold which may, in some examples, correspond to a total intended transmission size of the data payload.

In some examples, the first computing device may determine that a size of the data payload (e.g., plurality of data packets) received from the second computing device matches the transmission size threshold. In response, the first computing device may provide to the second computing device data indicating that the data payload was successfully received and may terminate the connection to the second computing device. The first computing device may store the data payload in a memory of the first computing device.

In some examples, at least one data packet of a configuration file stored in the memory of the first computing device may include a data enrichment identifier. In such examples, the first computing device may enrich the data payload based on the data enrichment identifier. More particularly, the first computing device may provide the data payload to a machine-learning model stored in a memory of the first computing device. The first computing device may generate an enriched data payload based on an output of the machine-learning model and may store the enriched data payload in the memory of the first computing device. In some examples, the first computing device may further determine a plurality of data insights associated with the enriched data payload based on the output of the machine-learning models. In some examples, the first computing device may be operable to surface the plurality of data insights to a user via a display device (e.g., local display device, remote display device, etc.).

Additionally and/or alternatively, in some examples, the first computing device may receive a subset of the plurality of data packets from the second computing device. The first computing device may determine that the subset of the plurality of data packets does not include data indicative of a transmission size threshold. In response, the first computing device may provide to the second computing device data indicating the data payload was not successfully received and may terminate the connection to the second computing device. Subsequent to terminating the connection, the first computing device may determine a reinitiation wait time based on a configuration stored in a memory of the first computing device. The first computing device may determine that the reinitiation wait time has elapsed and, subsequently, may reestablish a connection to the second computing device.

Subsequent to receiving the data payload from the second computing device, the first computing device may establish a connection to a wide area network (WAN) at a second location. For instance, the first computing device may move to a second location that is different from the first location. In some examples, the first computing device may include a navigation positioning system operable to generate geolocation data corresponding to a location of the first computing device. In such examples, the first computing device may determine that it is at the second location based on geolocation data generated by the navigation positioning system.

Responsive to determining that the first computing device is at the second location, the first computing device may establish a second communication link that is different from the first communication link. More particularly, the second communication link may correspond to the WAN. In some examples, the second communication link may be unavailable at the first location (e.g., the location of the second computing device(s)).

The first computing device may provide the data payload (e.g., received from the second computing device) to a remote computing device via the WAN. For instance, in some examples, at least one data packet of the data payload may include a service provider identifier associated with the second computing devices. The first computing device may determine a remote computing system (e.g., that includes the remote computing device) based on the service provider identifier. The first computing device may provide the data payload to a database of the remote computing system and, subsequently, may discard the data payload from the memory of the first computing device.

The present disclosure provides a number of technical effects and benefits, including improvements to computing technology. As one example, the present disclosure provides systems and methods for implementing asynchronous data transmission in locations and/or environments where network connectivity is otherwise limited and/or unavailable. As such, the systems described herein provide for increased network connectivity while, simultaneously, reducing the costs associated with deploying network resources to those locations and/or environments. Furthermore, the computing devices disclosed herein (e.g., peripheral computing device(s), collector computing device(s)) exchange data payloads (e.g., data packets) over a wireless personal area network (PAN), thereby reducing overall power draw associated with such data exchanges, increasing battery life and/or battery longevity, and/or the like. Even further, by waiting until the collector computing device returns to a central location to provide the data payload(s) (e.g., obtained from the peripheral computing device(s)) to the remote computing system, collector computing devices of the present disclosure reduce the risks of failed data transmission operations relative to data transmission operations from the location and/or environment of the peripheral computing device(s).

Furthermore, example aspects of the present disclosure provide resulting improvements to computing technology. As one example, reductions in power draw and processing requirements for peripheral computing device(s) may directly improve the operation speeds, data collection speeds, etc. of the peripheral computing devices. Likewise, processing and storage requirements for the peripheral computing devices and the collector computing devices may be directly reduced, ultimately resulting in more efficient resource use on both the peripheral-side and the collector-side. In this way, valuable computing resources that would otherwise be needed for data collection, storage, and transmission may be reserved for other tasks. Furthermore, by leveraging both public and/or private vehicle traffic (e.g., to travel between the central location and the locations associated with the peripheral computing devices), example aspects provide dynamic, efficient, and scalable processes for asynchronously transmitting data between the peripheral computing devices and the remote computing system.

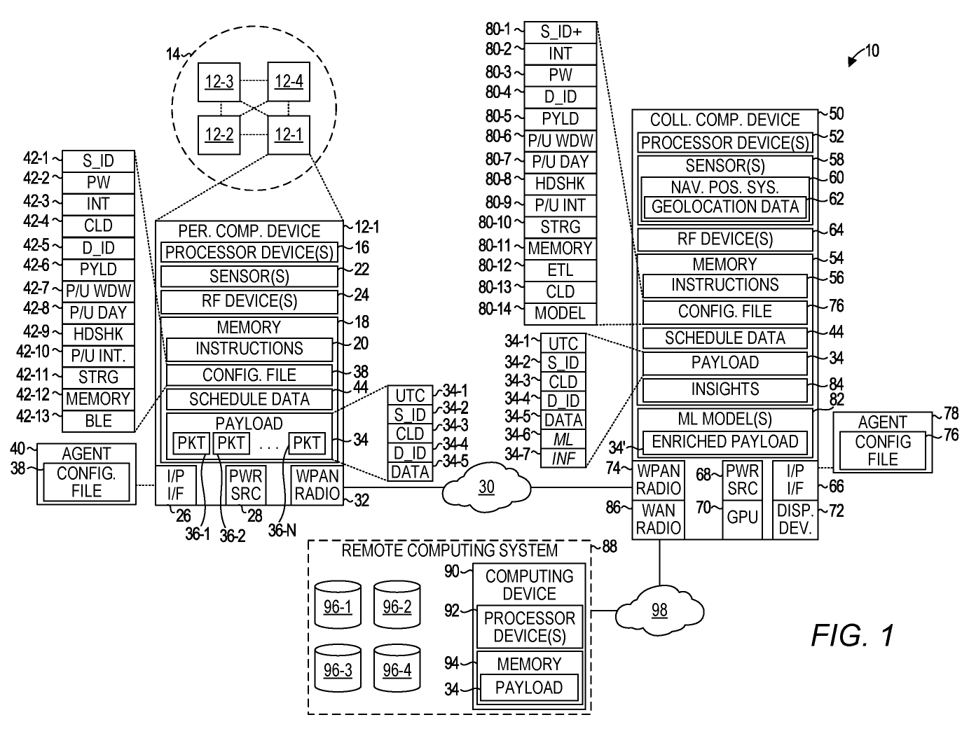

FIG. 1 is an example block diagram of an environment 10 suitable for implementing asynchronous data communication schemes, such as any of the asynchronous data communication schemes described herein. The environment 10 includes a peripheral computing device 12-1 (hereinafter, computing device 12-1). The computing device 12-1 may be one of a plurality of peripheral computing devices 12-1 – 12-4 (collectively, computing device(s) 12). It should be understood that only four computing devices 12 are depicted in FIG. 1 for purposes of illustration and discussion. Those having ordinary skill in the art, using the disclosures provided herein, will understand that any number of computing devices 12 may be included without deviating from the scope of the present disclosure.

In some examples, the plurality of computing devices 12-1 – 12-4 may collectively form a network 14 having any suitable network topology, such as a mesh topology, a star topology, a bus topology, a ring topology, a tree topology, a point-to-point topology, a point-to-multipoint topology, a hybrid topology, and/or the like. It should be understood that the network 14 (hereinafter, mesh network 14) is depicted in FIG. 1 as having a mesh topology for purposes of illustration and discussion. Those having ordinary skill in the art, using the disclosures provided herein, will understand that any suitable network topology may be used without deviating from the scope of the present disclosure.

The computing devices 12 may communicate with one another via any suitable transmission medium, such as, by way of non-limiting example, an optical transmission medium, an electrical transmission medium, a wireless transmission medium, and/or any combination thereof. The mesh network 14 may be any suitable communications network, such as, by way of non-limiting example, a local area network (LAN), wireless local area network (WLAN), personal area network (PAN), Long Range Radio (LoRa) network, or the like. For instance, wireless communication between the computing devices 12 may be performed via a wireless LAN, Wi-Fi, Bluetooth, ZigBee, Wi-Fi direct (WFD), ultra wideband (UWB), infrared data association (IrDA), Bluetooth low energy (BLE), near field communication (NFC), a radio frequency (RF) signal, and/or the like.

The computing device 12-1 may include a processor device 16. The processor device 16 may include any computing or electronic device(s) capable of executing software instructions to implement the functionality described herein. For example, the processor device 16 may be one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The processor device 16 may be a single processor device and/or a plurality of processor devices that are operatively connected, for instance, in a parallel configuration.

The computing device 12-1 may further include a memory 18. The memory 18 may be communicatively coupled to the processor device 16. The memory 18 may include executable instructions 20 that, when executed, cause the processor device 16 to perform operations, such as any of the operations described herein. In some examples, the memory 18 includes a controller (not shown) operable to implement the functionality described herein. Because the controller (not shown) is a component of the computing device 12-1, functionality implemented by the controller (not shown) may be attributed to the computing device 12-1 generally. Moreover, in examples where the controller (not shown) comprises software instructions (e.g., instructions 20) that program the processor device 16 to carry out the functionality described herein, functionality implemented by the controller (not shown) may be attributed to the processor device 16 and/or to the computing device 12-1 generally.

The memory 18 may be or otherwise include any device(s) capable of storing data, including, but not limited to, volatile memory (random access memory, etc.), non-volatile memory, storage device(s) (e.g., hard drive(s), solid state drive(s), etc.). For example, the memory device 18 may include one or more non-transitory computer-readable storage mediums, such as such as a Read Only Memory (ROM), Programmable Read Only Memory (PROM), Erasable Programmable Read Only Memory (EPROM), and flash memory, a USB drive, a volatile memory device such as a Random Access Memory (RAM), an internal or external hard disk drive (HDD), floppy disks, a blue-ray disk, or optical media such as CD ROM discs and DVDs, and combinations thereof. However, examples of the memory device 18 are not limited to the above description, and the memory device 18 may be realized by other various devices and structures as would be understood by those having ordinary skill in the art.

The computing device 12-1 may further include one or more sensors 22. The sensors 22 may include any suitable type of sensor, such as, by way of non-limiting example, Internet of Things (IoT)-related sensors, temperature sensors, humidity sensors, pressure sensors, proximity sensors, motion sensors, light sensors, gas sensors, water quality sensors, water level sensors, soil moisture sensors, pH sensors, air quality sensors, etc. It should be understood that the one or more sensors 22 may include any suitable sensor and/or combination of sensors without deviating from the scope of the present disclosure.

The computing device 12-1 may further include one or more radio frequency (RF) devices 24. In some examples, the computing device 12-1 may be operable to communicate with the other computing devices 12-2 – 12-4 of the mesh network 14 via the RF device 24. For instance, the computing device 12-1 may be operable to wirelessly transmit and/or receive data, such as data generated by the sensor(s) 22, to and/or from the other computing devices 12-2 – 12-4 via the RF device 24. As discussed in greater detail below, in some examples, the computing device 12-1 may be operable to transmit and/or receive an RF tag (not shown) to and/or from the other computing devices 12-1 – 12-4 via the RF device 24. For instance, in some examples, the RF device 24 may be operable to provide contextual information regarding the computing device 12-1 as a whole and/or various components and/or functions thereof in the form of an RF tag.

The computing device 12-1 may further include an input interface 26 (e.g., port). The input interface 26 may be any suitable interface, such as a parallel port, an Institute of Electrical and Electronic Engineers (IEEE) 1394 serial port, a Universal Serial Bus (USB) port (e.g., USB Type-A, USB Type-B, USB Type-C, USB Mini-A, USB Mini-B, USB Micro-A, USB Micro-B, etc.), an IR interface, and/or the like.

The computing device 12-1 may further include a power source 28, such as, by way of non-limiting example, any suitable internal and/or external battery. In some examples, the power source 28 may receive power, charge, and/or the like via the input interface 26. For instance, in some examples, the power source 28 may be charged by power supplied through the input interface 26. It should be understood that, although depicted as a battery in FIG. 1, the computing device 12-1 may include any suitable power source 28 without deviating from the scope of the present disclosure.

As will be discussed in greater detail below, the computing device 12-1 may be operable to establish a connection (e.g., a communication link) over network 30 to a collector computing device 50 (hereinafter, computing device 50). More particularly, the computing device 12-1 may establish a communication link with the computing device 50 via the RF device 24 and/or a network interface 32. The network 30 may be any suitable communications network, such as, by way of non-limiting example, a personal area network (PAN), Long Range Radio (LoRa) network, and/or the like. For instance, wireless communication between the computing device 12-1 and the computing device 50 may be performed via a wireless PAN, Wi-Fi, Bluetooth, ZigBee, Wi-Fi direct (WFD), infrared data association (IrDA), Bluetooth low energy (BLE), near field communication (NFC), a radio frequency (RF) signal, and/or the like.

In some examples, the computing device 12-1 may provide a data payload 34 to the computing device 50 via the network 30. The data payload 34 may include a plurality of data packets 36. In some examples, each of the plurality of data packets 36 may be generated by the computing device 12-1. In other examples, the plurality of data packets 36 may be respectively generated by at least one of the plurality of computing devices 12. As one illustrative example, each of the computing devices 12-2 – 12-4 may generate and provide one or more of the plurality of data packets 36 to the computing device 12-1 via the mesh network 14. As such, in some examples, each of the computing devices 12 of the mesh network 14 may be operable to provide data (e.g., one or more of the plurality of data packets 36) to the computing device 50 via the computing device 12-1.

The data payload 34 (e.g., data packets 36) provided to the computing device 50 by the computing device 12-1 may have any suitable body structure. For instance, as one illustrative example, the data payload 34 may include a date identifier 34-1; the date identifier 34-1 may, for instance, identify a date, time, etc., of the transmission of the data payload 34. In some examples, the data payload 34 may include a service profile identifier (ServiceID) 34-2; the service profile identifier 34-2 may, for instance, identify an account associated with a user, owner, operator, and/or the like of the computing device 12-1. In some examples, the data payload 34 may further include a service provider identifier 34-3; the service provider identifier 34-3 may, for instance, identify a final storage destination and/or intended recipient (e.g., cloud database, server computing system, etc.) for the data payload 34. In some examples, the data payload 34 may further include a device identifier 34-4; the device identifier 34-4 may, for instance, be a unique identifier that is used to identify a device (e.g., computing device 12-1 – 12-4) that generated data 34-5 included in the data payload 34.

It should be understood that the body structure of the data payload 34 described above is for purposes of illustration and discussion. Those having ordinary skill in the art, using the disclosures provided herein, will understand that other body structures be used by, and/or other information may be included in, the data payload 34 without deviating from the scope of the present disclosure.

The computing device 12-1 may perform any suitable boot process that initializes and configures the computing device 12-1 and its internal components such that the computing device 12-1 is operable to perform any of the asynchronous data transmission operations described herein. For instance, in some examples, the computing device 12-1 may be initialized and/or configured based on a configuration file 38. The configuration file 38 may be stored in the memory 18. In some examples, the configuration file 38 may be provided to the computing device 12-1 by a configuration agent 40 that is communicatively coupled to the computing device 12-1 via the input interface 26. The configuration file 38 may include and/or define a plurality of configuration parameters 42 for the computing device 12-1, such as any suitable configuration parameter for initializing and/or configuring the computing device 12-1 to perform the operations described herein.

By way of non-limiting illustrative example, the configuration parameters 42 may include a service profile identifier (ServiceID) 42-1. The service profile identifier 42-1 may be, for instance, a string (e.g., 13 bytes) identifying an account associated with a user, owner, operator, and/or the like of the computing device 12-1. In some examples, the service profile identifier 42-1 may correspond to the service profile identifier 34-2 of the data payload 34.

The configuration parameters 42 may further include a password 42-2. The password 42-2 may be, for instance, a string (e.g., 28 bytes) and may be encrypted using any suitable encryption technique, such as symmetric encryption, asymmetric encryption, and/or the like.

The configuration parameters 42 may further include an interval notification flag 42-3. The interval notification flag 42-3 may be, for instance, an integer (e.g., 4 bytes) that is used to indicate whether a capacity of the memory 18 is sufficient for the plurality of data packets 36 generated by the computing device(s) 12 of the mesh network 14.

The configuration parameters 42 may further include a service provider identifier 42-4. As will be discussed in greater detail below, the service provider identifier 42-4 may, for instance, identify a final storage destination and/or intended recipient (e.g., cloud database, server computing system, etc.) for the data payload 34. In some examples, the service provider identifier 42-4 may correspond to the service provider identifier 34-3 of the data payload 34.

The configuration parameters 42 may further include a device identifier (DeviceID) 42-5. The device identifier 42-5 may be, for instance, a string (e.g., 4 bytes) that is a unique identifier used to associate data (e.g., data packets 36) generated by the computing device 12-1 with the computing device 12-1. In some examples, the device identifier 42-5 may correspond to the device identifier 34-4 of the data payload 34.

The configuration parameters 42 may further include a transmission size threshold identifier 42-6. The transmission size threshold identifier 42-6 may, for instance, be a data structure (e.g., 255 bytes) that indicates a size of the data payload 34. In some examples, the computing device 12-1 may provide (e.g., via network 30) the transmission size threshold identifier 42-6 to the computing device 50 prior to and/or contemporaneously with the data payload 34.

The configuration parameters 42 may further include an advertisement window identifier 42-7. The advertisement window identifier 42-7 may, for instance, be an integer (e.g., 1 byte) that indicates an hour of the day the computing device 12-1 begins transmitting advertisement data packets (e.g., for receipt by the computing device 50).

The configuration parameters 42 may further include a pickup day identifier 42-8. The pickup day identifier 42-8 may, for instance, be an integer (e.g., 4 bytes) that indicates a day of the month the computing device 12-1 begins transmitting advertisement data packets (e.g., for receipt by the computing device 50).

The configuration parameters 42 may further include a reinitiation wait time identifier 42-9. The reinitiation wait time identifier 42-9 may, for instance, be an integer (e.g., 4 bytes) that indicates a time (e.g., in seconds (s)) the computing device 12-1 is to wait following a failed handshake (e.g., connection) with the computing device 50 to reestablish a communication link (e.g, connection) with the computing device 50 (e.g., via network 30).

The configuration parameters 42 may further include a pickup interval identifier 42-10. The pickup interval identifier 42-10 may, for instance, be a string (e.g., 28 bytes) that indicates an interval (e.g., daily, weekly, monthly, yearly, etc.) the computing device 12-1 provides the data payload 34 to the computing device 50.

The configuration parameters 42 may further include a storage size identifier 42-11. The storage size identifier 42-11 may, for instance, be an integer (e.g., 4 bytes) that is indicative of an amount of storage (e.g., total size) which is shared between the memory 18 of the computing devices 12 each time the computing device 12-1 provides the data payload 34 to the computing device 50.

The configuration parameters 42 may further include a memory utilization identifier 42-12. The memory utilization identifier 42-12 may, for instance, be an integer (e.g., 4 bytes) that indicates whether the data payload 34 is erased (e.g., “delete” mode) or maintained (e.g., “circular overwrite” mode) following transmission to the computing device 50.

The configuration parameters 42 may further include a mesh mode identifier 42-13. The mesh mode identifier 42-13 may, for instance, be an integer (e.g., 4 bytes) that indicates whether the computing device 12-1 is operating in as a proxy for the computing devices 12-2 – 12-4 of the mesh network 14. That is, the mesh mode identifier 42-13 may indicate whether the data payload 34 includes data packets 36 generated by any of the other computing devices 12-2 – 12-4 of the mesh network 14.

As noted above, the computing device 50 may, as one non-limiting example, be affixed to a vehicle and, as such, may be operable to move between various locations of the environment 10. For instance, in some examples, the computing device 50 may be affixed and/or be part of a vehicle that follows a standard and/or regular route. In such examples, the computing device 12-1 may store schedule data 44 indicative of a route, schedule, etc. associated with the computing device 50. In some examples, the schedule data 44 may be provided to the computing device 12-1 in the configuration file 38 (e.g., advertisement window identifier 42-7, pickup day identifier 42-8, pickup interval identifier 42-10, etc.). In some examples, the schedule data 44 may be provided by a user via the input interface 26, the network interface 32, and/or the like.

The computing device 50 may be operable to obtain the data payload 34 from the computing device 12-1. As shown, the computing device 50 may include a processor device 52. The processor device 52 may include any computing or electronic device(s) capable of executing software instructions to implement the functionality described herein. For example, the processor device 16 may be one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The processor device 16 may be a single processor device and/or a plurality of processor devices that are operatively connected, for instance, in a parallel configuration.

The computing device 50 may further include a memory 54. The memory 54 may be communicatively coupled to the processor device 52. The memory 54 may include executable instructions 56 that, when executed, cause the processor device 52 to perform operations, such as any of the operations described herein. In some examples, the memory 54 includes a controller (not shown) operable to implement the functionality described herein. Because the controller (not shown) is a component of the computing device 50, functionality implemented by the controller (not shown) may be attributed to the computing device 50 generally. Moreover, in examples where the controller (not shown) comprises software instructions (e.g., instructions 56) that program the processor device 52 to carry out the functionality described herein, functionality implemented by the controller (not shown) may be attributed to the processor device 52 and/or to the computing device 50 generally.

The memory 54 may be or otherwise include any device(s) capable of storing data, including, but not limited to, volatile memory (random access memory, etc.), non-volatile memory, storage device(s) (e.g., hard drive(s), solid state drive(s), etc.). For example, the memory device 54 may include one or more non-transitory computer-readable storage mediums, such as such as a Read Only Memory (ROM), Programmable Read Only Memory (PROM), Erasable Programmable Read Only Memory (EPROM), and flash memory, a USB drive, a volatile memory device such as a Random Access Memory (RAM), an internal or external hard disk drive (HDD), floppy disks, a blue-ray disk, or optical media such as CD ROM discs and DVDs, and combinations thereof. However, examples of the memory device 54 are not limited to the above description, and the memory device 54 may be realized by other various devices and structures as would be understood by those having ordinary skill in the art.

The computing device 50 may further include one or more sensors 58. For instance, in some examples, the computing device 50 may include a navigation positioning system 60. As will be discussed in greater detail below, the navigation positioning system 60 may be operable to generate geolocation data 62, which may correspond to a location (e.g., physical location) of the computing device 50. For instance, in some examples, the navigation positioning system 60 may be a Global Positioning System (GPS) device operable to obtain GPS coordinates associated with the physical location of the computing device 50.

The computing device 50 may further include one or more radio frequency (RF) devices 64. In some examples, the computing device 50 may be operable to communicate with the other computing devices 12 of the mesh network 14 via the RF device 64. For instance, the computing device 50 may be operable to wirelessly transmit and/or receive data, such as data generated by the computing devices 12, via the RF device 64. In some examples, the computing device 50 may be operable to receive the data payload 34 and/or an RF tag (not shown) from the computing devices 12-1 – 12-4 via the RF device 64. For instance, as will be discussed in greater detail below, the RF device 64 may emit an interrogation probe (e.g., up to and including 1 Watt equivalent isotropic radiated power (EIRP)). In some examples, such as when the computing device 50 is in the vicinity of the computing device 12-1, computing device 12-1 may respond to the interrogation probe by communicating data (e.g., RF tag, data payload 34, etc.) to the computing device 50 via the RF device 24. In such examples, the computing device 50 may receive the data from the computing device 12-1 via the RF device 64 and, subsequently, store the received data in the memory 54.

The computing device 50 may further include an input interface 66 (e.g., port). The input interface 66 may be any suitable interface, such as a parallel port, an Institute of Electrical and Electronic Engineers (IEEE) 1394 serial port, a Universal Serial Bus (USB) port (e.g., USB Type-A, USB Type-B, USB Type-C, USB Mini-A, USB Mini-B, USB Micro-A, USB Micro-B, etc.), an IR interface, and/or the like.

The computing device 50 may further include a power source 68, such as, by way of non-limiting example, any suitable internal and/or external battery. In some examples, the power source 68 may receive power, charge, and/or the like via the input interface 66. For instance, in some examples, the power source 68 may be charged by power supplied through the input interface 66. It should be understood that, although depicted as a battery in FIG. 1, the computing device 50 may include any suitable power source 68 without deviating from the scope of the present disclosure.

In some examples, the computing device 50 may further include a graphics processing unit (GPU) 70 and a display device 72. In some examples, the display device 72 may be local to the computing device 50. In other examples, the display device 72 may be a remote display device that is communicatively coupled to the computing device 50. The display device 72 may include any suitable display, such as a Liquid Crystal on Silicon (LCOS) display, a Light-Emitting Diode (LED) display, an Organic Light-Emitting Diode (OLED) display, a Liquid Crystal Display (LCD), an Active Matrix Organic Light-Emitting Diode (AMOLED) display, a flexible display, a 3D display, a Plasma Display Panel (PDP), a Cathode Ray Tube (CRT) display, and/or the like, on which imagery is presented. It should be understood that any suitable display device 72 may be used without deviating from the scope of the present disclosure.

As noted above, the computing device 50 may establish a connection (e.g., a communication link) over the network 30 to the computing device 12-1. More particularly, the computing device 50 may establish a communication link with the computing device 12-1 via the RF device 64 and/or a network interface 74. Like the network interface 32 described above with reference to the computing device 12-1, the network interface 74 of the computing device 50 may be operable to wireless communicate with other device via a wireless PAN, Wi-Fi, Bluetooth, ZigBee, Wi-Fi direct (WFD), infrared data association (IrDA), Bluetooth low energy (BLE), near field communication (NFC), a radio frequency (RF) signal, and/or the like.

The computing device 50 may perform any suitable boot process that initializes and configures the computing device 50 and its internal components such that the computing device 50 is operable to perform any of the asynchronous data transmission operations described herein. For instance, in some examples, the computing device 50 may be initialized and/or configured based on a configuration file 76. The configuration file 76 may be stored in the memory 54. In some examples, the configuration file 76 may be provided to the computing device 50 by a configuration agent 78 that is communicatively coupled to the computing device 50 via the input interface 66. In some examples, the configuration file 76 may be wirelessly transmitted to the computing device 50 (e.g., via network interface 86). The configuration file 76 may include and/or define a plurality of configuration parameters 80 for the computing device 50, such as any suitable configuration parameter for initializing and/or configuring the computing device 50 to perform the operations described herein.

By way of non-limiting illustrative example, the configuration parameters 80 may include a service/location identifier (ServiceID) 80-1. The service/location identifier 80-1 may be, for instance, a string (e.g., 28 bytes) identifying an account associated with a user, owner, operator, and/or the like of the computing device 50 and/or the computing device 12-1. The service/location identifier 80-1 may also identify a location (e.g., network location, physical location, etc.) associated with the user, owner, operator, and/or the like of the computing device 50 and/or the computing device 12-1.

The configuration parameters 80 may further include an interval notification 80-2. The interval notification 80-2 may be, for instance, an integer (e.g., 4 bytes) that indicates whether adjustments to data transmission operations is needed based on software and/or hardware limitations associated with a peripheral computing device (e.g., computing device(s) 12). In some examples, the interval notification 80-2 may be associated with the interval notification flag 42-3 of the configuration file 38.

The configuration parameters 80 may further include a password 80-3. The password 80-3 may be, for instance, a string (e.g., 28 bytes) and may be encrypted using any suitable encryption technique, such as symmetric encryption, asymmetric encryption, and/or the like. In some examples, the password 80-3 may correspond to the password 42-2 of the configuration file 38.

The configuration parameters 80 may further include a device identifier (DeviceID) 80-4. The device identifier 80-4 may be, for instance, a string (e.g., 28 bytes) that is a unique identifier used to associate data (e.g., data payload 34) stored by the computing device 50 with the computing device 50.

The configuration parameters 80 may further include a transmission size threshold identifier 80-5. The transmission size threshold identifier 80-5 may, for instance, be a data structure (e.g., 255 bytes) that indicates a size of a data payload to be received by the computing device 50, such as the data payload 34. In some examples, the transmission size threshold identifier 80-5 may correspond to the transmission size identifier 42-6 of the configuration file 38.

The configuration parameters 80 may further include an advertisement window identifier 80-6. The advertisement window identifier 80-6 may, for instance, be an integer (e.g., 1 byte) that indicates an hour of the day the computing device 50 begins listening for advertisement data packets (e.g., from the computing device 12-1). In some examples, the advertisement window identifier 80-6 may correspond to the advertisement window identifier 42-7 of the configuration file 38.

The configuration parameters 80 may further include a pickup day identifier 80-7. The pickup day identifier 80-7 may, for instance, be an integer (e.g., 4 bytes) that indicates a day of the month the computing device 50 begins listening for advertisement data packets (e.g., from the computing device 12-1). In some examples, the pickup day identifier 80-7 may correspond to the pickup day identifier 42-8 of the configuration file 38.

The configuration parameters 80 may further include a reinitiation wait time identifier 80-8. The reinitiation wait time identifier 80-8 may, for instance, be an integer (e.g., 4 bytes) that indicates a time (e.g., in seconds (s)) the computing device 50 is to wait following a failed handshake (e.g., connection) with a peripheral computing device (e.g., computing device(s) 12) to reestablish a communication link (e.g., connection) with the peripheral computing device (e.g., via network 30). In some examples, the reinitiation wait time identifier 80-8 may correspond to the reinitiation wait time identifier 42-9 of the configuration file 38. In other examples, the reinitiation wait time identifier 80-8 may be different from the reinitiation wait time identifier 42-9 of the configuration file 38.

The configuration parameters 80 may further include a pickup interval identifier 80-9. The pickup interval identifier 80-9 may, for instance, be a string (e.g., 28 bytes) that indicates an interval (e.g., daily, weekly, monthly, yearly, etc.) the computing device 50 obtains a data payload (e.g., data payload 34) from a peripheral computing device (e.g., computing device(s) 12). In some examples, the pickup interval identifier 80-9 may correspond to the pickup interval identifier 42-10 of the configuration file 38.

The configuration parameters 80 may further include a storage size identifier 80-10. The storage size identifier 80-10 may, for instance, be an integer (e.g., 4 bytes) that is indicative of an amount of storage (e.g., total size) which is shared between a peripheral computing device (e.g., computing device(s) 12) during each data payload transmission. In some examples, the storage size identifier 80-10 may correspond to the storage size identifier 42-11 of the configuration file 38.

The configuration parameters 80 may further include a memory utilization identifier 80-11. The memory utilization identifier 80-11 may, for instance, be an integer (e.g., 4 bytes) that indicates whether the data payload 34 is erased (e.g., “delete” mode) or maintained (e.g., “circular overwrite” mode) following transmission to a destination computing device. In some examples, the memory utilization identifier 80-11 may correspond to the memory utilization identifier 42-12 of the configuration file 38.

The configuration parameters 80 may further include an enrichment identifier 80-12. The enrichment identifier 80-12 may be, for instance, a data structure indicating whether a data payload (e.g., data payload 34) is to be enriched following receipt from a peripheral computing device (e.g., computing device(s) 12). For instance, the computing device 50 may be operable to enrich the data payload 34 (e.g., data packets 36). In particular, as will be discussed in greater detail below, the computing device 50 may include a machine-learning model 82. The computing device 50 may be further operable to generate an enriched data payload 34' and/or a plurality of data insights 84 based on an output of the machine-learning model 82. In some examples, the computing device 50 may provide the plurality of data insights 84 associated with the enriched data payload 34' to a display device, such as display device 72.

The configuration parameters 80 may further include cloud credentials 80-13. The cloud credentials 80-13 may be, for instance, a string (e.g., 28 bytes) that includes credentials for accessing a remote computing system (e.g., remote computing system 88).

The configuration parameters 80 may further include machine-learning model identifier 80-14. The machine-learning model identifier 80-14 may be, for instance, a string (e.g., 64 bytes) that identifies a machine-learning model (e.g., machine-learning model 82) for enriching a data payload (e.g., data payload 34) received from a peripheral computing device (e.g., computing device(s) 12).

As noted above, in some examples, the computing device 50 may include a machine-learning model 82. It should be understood that the machine-learning model 82 may be any suitable machine-learning model, such as a neural network (e.g., deep neural network, feed-forward neural network, recurrent neural network, convolutional neural network, etc.) and/or other types of machine-learning models (e.g., non-linear models, linear models, etc.). In some examples, the machine-learning model 82 may be trained using an unsupervised training algorithm (e.g., K-means, hierarchical clustering, etc.) to refine the machine-learning model 82 and its corresponding outputs.

As a non-limiting illustrative example, the computing device 50 may be configured to enrich data (e.g., data payload 34) received from a peripheral computing device (e.g., computing device 12-1) based on the enrichment identifier 80-12 of the configuration file 76. In such examples, upon receiving the data payload 34 from the computing device 12-1, the computing device 50 may provide the data payload 34 (e.g., data 34-5) to the machine-learning model 82, which processes the data payload 34 and generates an enriched data payload 34'. Additionally and/or alternatively, in examples where the computing device 12-1 provides an RF tag (e.g., with contextual information associated with one or more of the computing devices 12 of the mesh network 14) to the computing device 50 (e.g., via RF devices 24, 64), the information of the RF tag (not shown) may also be used by the computing device 50 to generate the enriched data payload 34'.

As used herein, “data enrichment” refers to a process of enhancing, refining, augmenting, etc. raw data by adding relevant information that contextualizes the raw data, corrects errors in the raw data, improves the accuracy of the raw data, classifies and/or tags the raw data, and/or the like. Those having ordinary skill in the art, using the disclosures provided herein, will understand that any suitable data enrichment process may be used without deviating from the scope of the present disclosure.

More particularly, the machine-learning model 82 may be configured to perform a data enrichment process on the data payload 34, such as Extract-Transform-Load (ETL), to enhance the quality, completeness, usefulness, etc. of the data payload 34. For instance, in some examples, the data payload 34 may include extraneous data, such as duplicative data, erroneous data, and/or the like. In such examples, the computing device 50 may be operable to enrich the data payload 34 by transforming the extraneous data into data that is useful, usable, consistent, etc. prior to persisting the data payload 34 to the memory 54. Hence, in some examples, the enriched data payload 34' may reduce an amount of data that is stored by, and ultimately transmitted by, the computing device 50.

In some examples, the computing device 50 may be further configured to generate a plurality of data insights 84 based on an output of the machine-learning model 82. More particularly, the plurality of data insights 84 may identify patterns, trends, relationships, anomalies, etc. that would otherwise not be identifiable based on the raw data (e.g., data 34-5) of the data payload 34, thereby contextualizing the data received from the computing devices 12.

Upon receiving the data payload 34 from the computing device 12-1, the computing device 50 may be configured to store the data payload 34 in the memory 54. For instance, in some examples, the memory 54 may include a relational database. In such examples, the data payload 34 may be stored in the memory 54 using a schema that includes the corresponding data identifier 34-1, service profile identifier 34-2, service provider identifier 34-3, device identifier 34-4, and the data 34-5. In examples where the computing device 50 generates an enriched data payload 34', the schema may further include a machine-learning model identifier 34-6 (e.g., corresponding to the machine-learning model identifier 80-14) and/or insight data (e.g., corresponding to the plurality of data insights 84).

The computing device 50 may further include a wide area network (WAN) interface 86 that provides internet connectivity via a wireless communication link. In particular, the WAN interface 86 is operable to provide for communication over a wireless WAN network 98 (hereinafter, network 98), such as a cellular network (e.g., Fourth Generation (4G) networks, Fifth Generation (5G) networks, etc.).

As will be discussed in greater detail below, the computing device 50 may be operable to establish a connection (e.g., communication link) over the network 98 to a remote computing system 88. The remote computing system 88 may include one or more remote computing device(s) 90. The remote computing device(s) may include a processor device 92 and a memory 94. The remote computing system 88 may further include one or more cloud databases, such as databases 96-1 – 96-4 (collectively, databases 96). In some examples, each database 96 may be owned, operated, maintained, and/or otherwise associated with a different service provider.

As noted above, the computing device 50 may obtain a data payload (e.g., data payload 34) from the computing device 12-1. In some examples, the computing device 50 may establish a communication link (e.g., connection) with the remote computing system 88 and, subsequently, may provide the data payload 34 obtained from the computing device 12-1 to the remote computing system 88 for storage. In some examples, the data payload 34 may be stored in the memory 94 of the remote computing device 90. In some examples, the data payload 34 may be stored in one of the databases 96 (e.g., identified based on the service provider identifier 42-4 of the configuration file 38, the service provider identifier 34-3 of the data payload 34, and/or the cloud credentials 80-13 of the configuration file 76). In some examples, the data payload 34 may be stored in the remote computing system 88 using a similar schema as set forth above with reference to the computing device 50.

With this background, example aspects of the present disclosure are directed to asynchronous data transmission operations. More particularly, as shown in FIG. 1, the computing devices 12 of the mesh network 14 are not equipped and/or configured to establish a connection to the remote computing system 88. That is, the computing devices 12 are unable to operate over the network 98 and, as such, are unable to offload data to the remote computing device 90 and/or to the databases 96 of the remote computing system 88. In contrast, the computing device 50 is equipped and/or configured to establish a connection to the remote computing system 88 and, as such, may operate as a proxy device for storing and delivering data (e.g., data payload 34) generated by the computing devices 12 to the remote computing system 88 for storage (e.g., in databases 96).

More particularly, the computing device 50 may establish a connection (e.g., via the network 30) to the computing device 12-1 at a first location. As discussed in greater detail below, the first location may correspond to a general location of the computing device 12-1 (e.g., a location within range of the network interface 32). After the connection is established, the computing device 50 may obtain the data payload 34 from the computing device 12-1. As described herein, the data payload 34 may include a plurality of data packets 36 generated by at least one (or more) of the computing devices 12 of the mesh network 14. The computing device 50 may then establish a connection to the network 98 at a second location that is different from the first location. As discussed in greater detail below, the second location may correspond to a central location (e.g., location of origin) of the computing device 50 where the network 98 is accessible. Subsequent to establishing the connection to the network 98, the computing device 50 may provide the data payload 34 obtained from the computing device 12-1 to the remote computing system 88 (e.g., remote computing device 90, databases 96, etc.) via the network 98. In this way, the computing device 50 is operable to facilitate asynchronous data transmission between the computing devices 12 and the remote computing system 88.

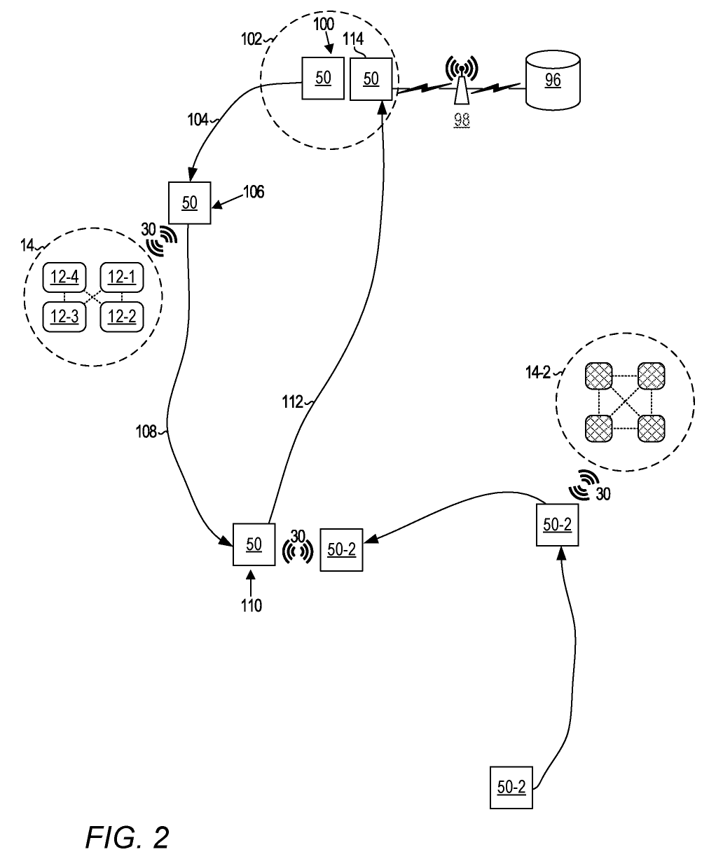

FIG. 2 depicts an illustrative example of the asynchronous data transmission operations described herein according to some implementations of the present disclosure. FIG. 2 will be discussed in conjunction with FIG. 1.

At 100, a first computing device, such as the computing device 50, is at a central location 102. As shown, the computing device 50 is operable to establish a communication link with the network 98 at the central location 102.

At 104, the computing device 50 travels from the central location 102 to a first location 106. As one non-limiting illustrative example, the first location 106 may correspond to a rural location where a connection to the network 98 is unavailable.

At the first location 106, the computing device 50 establishes a connection to a second computing device, such as the computing device 12-1. In some examples, such as that depicted in FIG. 2, the computing device 12-1 may be an anchor computing device of the mesh network 14. More particularly, at the first location 106, the computing device 50-1 receives an advertisement data packet from the computing device 12-1 and, in response, provides an acknowledgement packet (e.g., indicating the advertisement data packet was successfully received) and/or a connection request to the computing device 12-1. Subsequently, the computing device 50 establishes a first communication link with the computing device 12-1 via the network 30 and obtains the data payload 34 (e.g., packets 36) from the computing device 12-1.

The computing device 50 determines that the data payload 34 was successfully received from the computing device 12-1, stores the data payload 34 in the memory 18, and terminates the connection to the computing device 12-1. As discussed herein, in some examples, the computing device 50 may enrich the data payload 34 received from the computing device 12-1 to generate the enriched data payload 34'.

At 108, the computing device 50 travels from the first location 106 to a location 110. The location 110 may be similar to the first location 106. At the second location 110, the computing device 50 may obtain a data payload (e.g., data payload 34) that was collected by another computing device similar to the computing device 50 (e.g., computing device 50-2). For instance, in the example of FIG. 2, the other computing device 50-2 provides a data payload (not shown) to the computing device 50 that was collected by one or more computing devices of another mesh network 14-2.

At 112, the computing device 50 travels from the location 110 to a second location 114 that may, in some examples, correspond to the central location 102. The computing device 50 may obtain geolocation data 62 via the navigation positioning system 60 and may determines that the computing device 50 is at the second location 114 (e.g., central location 102) based on the geolocation data 62.

At the second location 114 (e.g., central location 102), the computing device 50 may establish a second communication link with the network 98 (e.g., via the network interface 86) and may provide the data payload 34 to the remote computing system 88. For instance, in some examples, at least one data packet 36 of the data payload 34 may include a service profile identifier 42-1 associated with the computing device 12-1. In such examples, the computing device 50 may determine the remote computing system 88 of a plurality of remote computing systems based on the service profile identifier 42-1.

In this manner, the computing device 50 is operable to facilitate asynchronous data transmission between the computing devices 12 and the remote computing system 88.

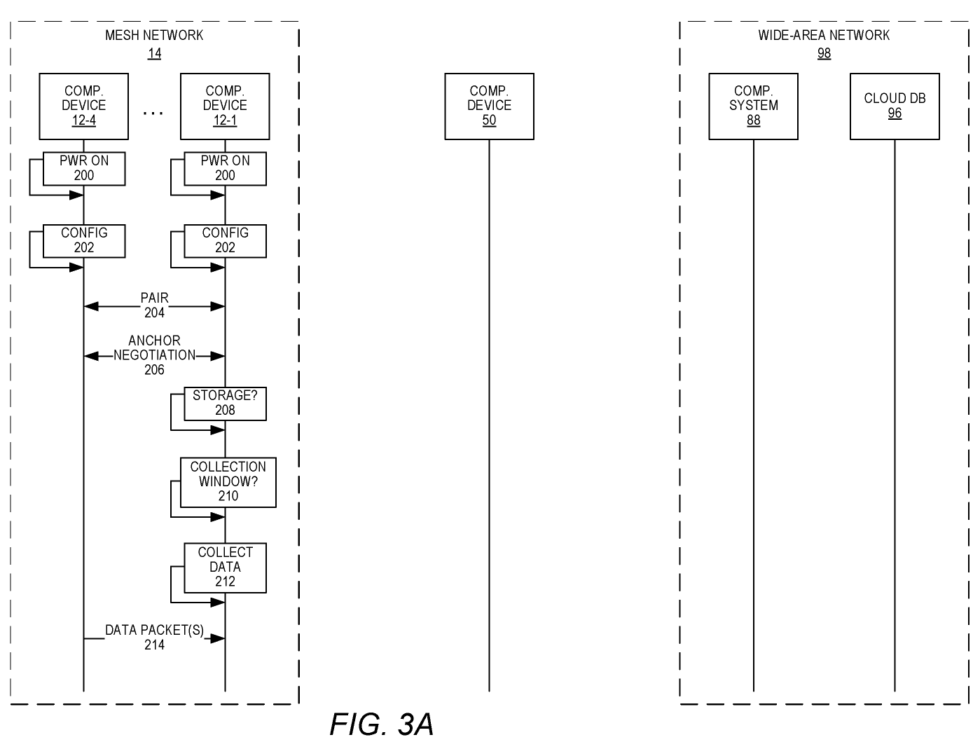

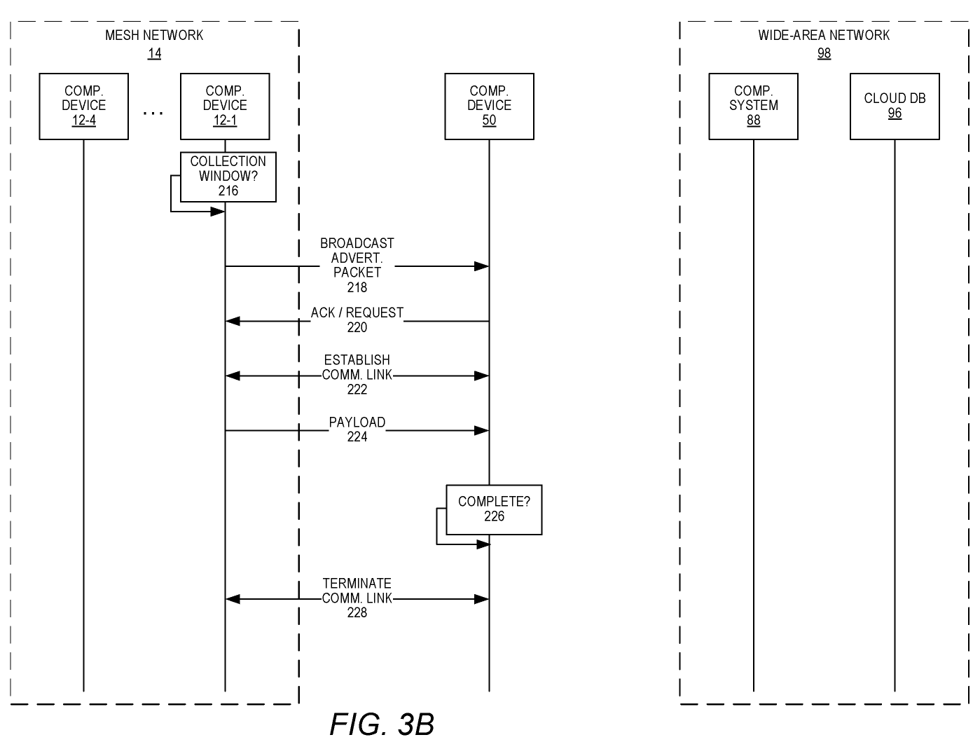

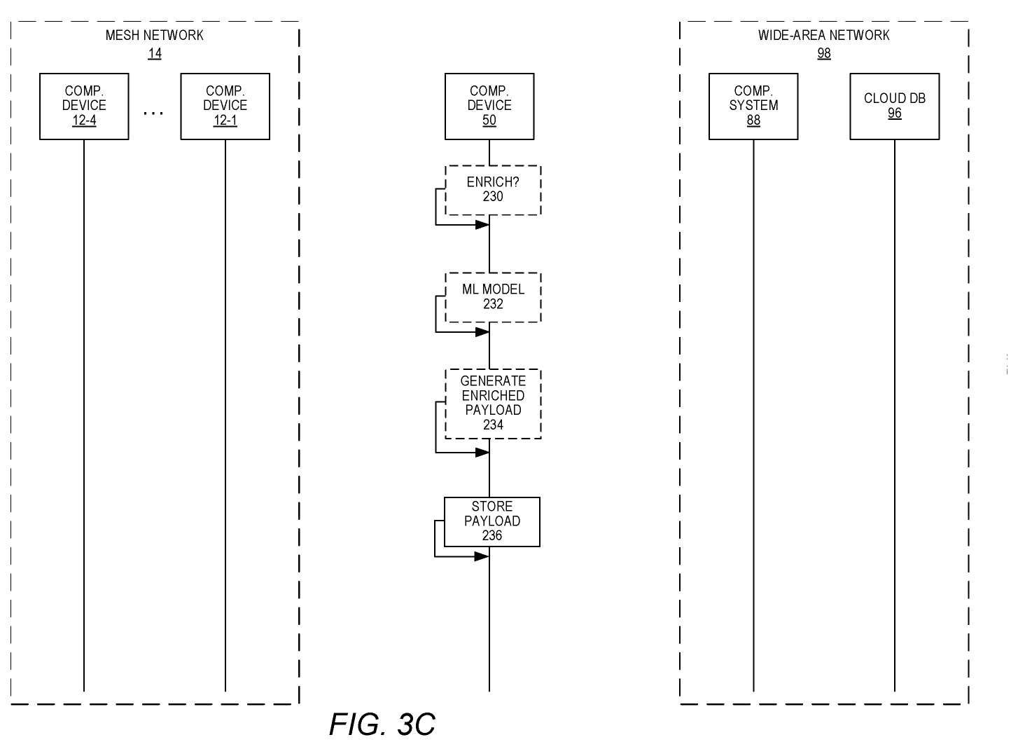

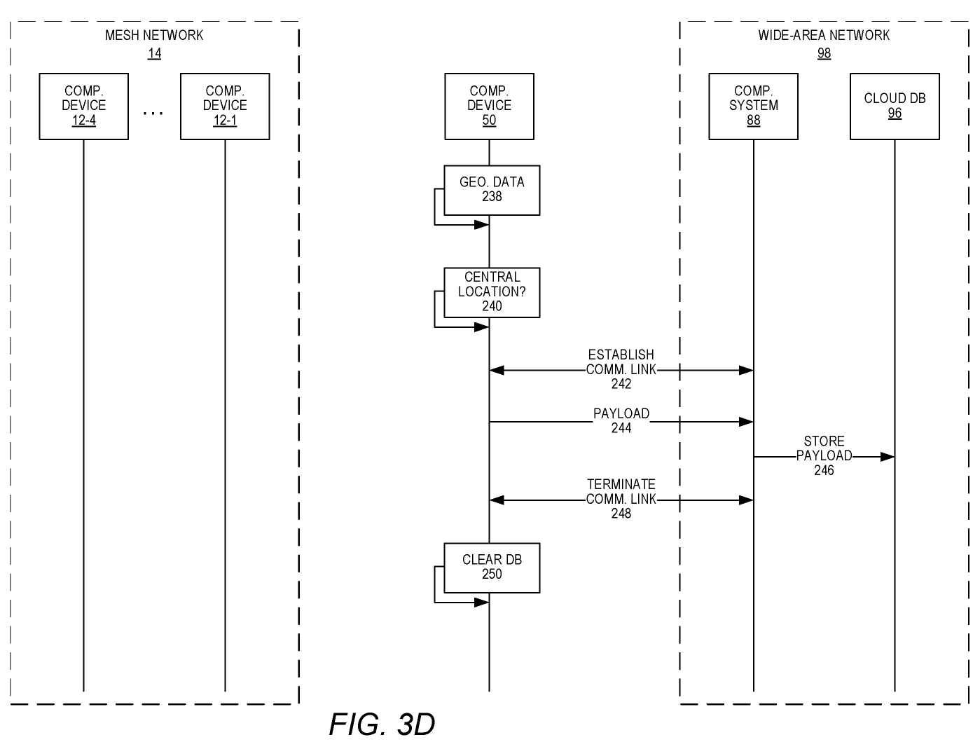

FIG. 3A–3D depict sequence diagrams illustrating messages communicated between and actions taken by certain components illustrated in FIG. 1 to perform the asynchronous data transmission operations described herein according to some implementations of the present disclosure. FIG. 3A–3D will be discussed in conjunction with FIG. 1.

Referring to FIG. 3A, the computing devices 12 power on (FIG. 3A, step 200). Each computing device 12 is configured based on a respective configuration file 38 stored in the memory 18 (FIG. 3A, step 202). Each computing device 12 may pair with one another to form the mesh network 14 (FIG. 3A, step 204).

The computing devices 12 of the mesh network 14 may determine an anchor computing device, which refers to the computing device through which data (e.g., data packets 36) will be transmitted to the remote computing system 88 for storage (FIG. 3A, step 206). In some examples, the anchor computing device may be determined based on the schedule data 44. For instance, by way of non-limiting example, the schedule data 44 may indicate that the computing device 50 will be proximate to the computing device 12-1, but not the computing devices 12-2 – 12-4, during the collection window. In such examples, the computing device 12-1 may be determined to be the anchor computing device for the mesh network 14. For purposes of illustration and discussion, the computing device 12-1 is the anchor computing device.

Once elected as the anchor computing device, the computing device 12-1 determines whether the memory 18 is sufficient to store the data generated by the sensors 22 and the plurality of data packets 36 generated by the computing devices 12 of the mesh network 14 (FIG. 3A, step 208). The computing device 12-1 determines the memory 18 is sufficient and determines whether to enter a collection window (FIG. 3A, step 210). The computing device 12-1 determines not to enter the collection window and, instead, obtains data via the sensors 22 (FIG. 3A, step 212). The computing device 12-1 also obtains data (e.g., data packets 36) generated by the computing devices 12 of the mesh network 14 via the network interface 32 (FIG. 3A, step 214).

Referring now to FIG. 3B, the computing device 12-1 subsequently determines to enter the collection window (FIG. 3B, step 216). Subsequently, the computing device 12-1 transmits (e.g., broadcasts) a plurality of advertisement data packets (FIG. 3B, step 218).

The computing device 50 receives one of the plurality of advertisement data packets from the computing device 12-1 and, in response, provides an acknowledgement signal and connection request to the computing device 12-1 (FIG. 3B, step 220). The computing device 50 then establishes a communication link with the computing device 12-1 via the network 30 (FIG. 3B, step 222).

The computing device 50 obtains the data payload 34 (e.g., the data packets 36) from the computing device 12-1 (FIG. 3B, step 224). The computing device 50 determines whether the data payload 34 has been successfully received (e.g., based on the transmission size threshold identifier 42-6 received from the computing device 12-1, the transmission size threshold identifier 80-5 of the configuration file 76, etc.) (FIG. 3B, step 226). In response to determining a size of the data payload 34 matches the transmission size threshold identifier (e.g., transmission size threshold identifier 42-6, transmission size threshold identifier 80-5, etc.), the computing device 50 terminates the communication link with the computing device 12-1 (FIG. 3B, step 228).

Referring to FIG. 3C, in some examples, the computing device 50 determines whether to enrich the data payload 34 based, for instance, on the enrichment identifier 80-12 of the configuration file 76 (FIG. 3C, step 230). If the computing device 50 determines to enrich the data payload 34, the computing device 50 provides the data payload 34 to the machine-learning model 82 (FIG. 3C, step 232) and generates the enriched payload 34' based on an output of the machine-learning model 82 (FIG. 3C, step 234). The computing device 50 stores the data payload 34 and/or the enriched data payload 34' in the memory 54 (FIG. 3C, step 236).

Referring to FIG. 3D, the computing device 50 obtains geolocation data 62 via the navigation positioning system 60 (FIG. 3D, step 238) and determines whether the computing device 50 is at a central location based on the geolocation data 62 (FIG. 3D, step 240). In response to determining the computing device 50 is at the central location, the computing device 50 establishes a communication link with the remote computing system 88 via the network 98 (FIG. 3D, step 242). The computing device 50 provides the data payload 34 (e.g., received from the computing devices 12) to the remote computing system 88 via the network 98 (FIG. 3D , step 244).

The remote computing system 88 receives the data payload 34 from the computing device 12 and stores the data payload 34, for instance, in the cloud databases (e.g., databases 96-1 – 96-4) of the remote computing system 88 (FIG. 3D, step 246). Additionally and/or alternatively, in some examples, the remote computing system 88 may store the data payload 34 in the memory 94 of a remote computing device 90 of the remote computing system 88.

After providing the data payload 34 to the remote computing system 88, the computing device 50 terminates the communication link with the remote computing system (FIG. 3D, step 248). The computing device 50 determines the computing device 50 is in a “delete mode” (e.g., based on the memory utilization identifier 80-11 of the configuration file 76) and discards the data payload 34 from the memory 54 (FIG. 3D, step 250).

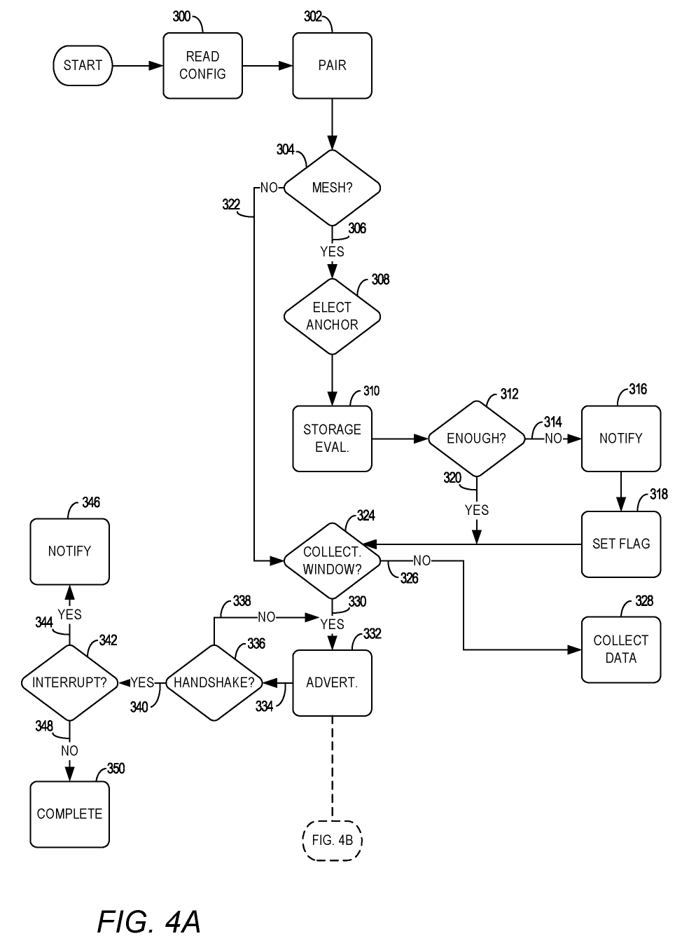

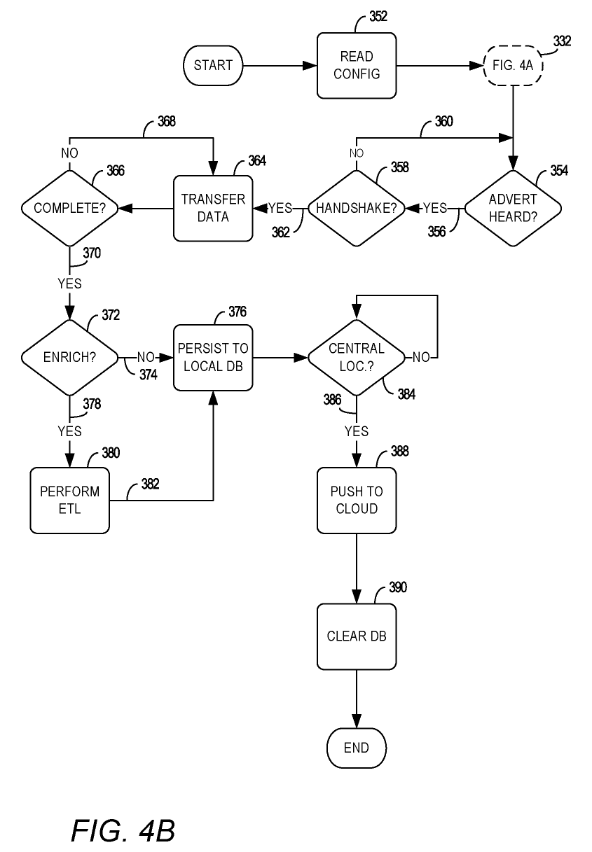

FIG. 4A–4B depict flowcharts of an example asynchronous data transmission method according to some implementations of the present disclosure. FIG. 4A–4B will be discussed in conjunction with FIG. 1.

Referring to FIG. 4A, the computing device 12-1 is configured based on the configuration file 38 (FIG. 4A, block 300). The computing device 12-1 pairs with the other computing devices 12-2 – 12-4 to form the mesh network 14 (FIG. 4A, block 302). The computing device 12-1 determines whether a mesh configuration parameter is enabled based on, for instance, the mesh mode identifier 42-13 of the configuration file 38 (FIG. 4A, block 304).

When the mesh configuration parameter is enabled (FIG. 4A, block 306), the computing devices 12 of the mesh network 14 perform anchor negotiations to determine which of the computing devices 12 of the mesh network 14 will operate as an anchor computing device (FIG. 4A, block 308). As described above, the anchor computing device is the computing device 12 of the mesh network 14 that establishes a connection and transmits data to the computing device 50.

For purposes of illustration and discussion, the computing device 12-1 is elected as the anchor computing device. After being elected as the anchor computing device for the mesh network 14, the computing device 12-1 evaluates a storage of the memory 18 (FIG. 4A, block 310) and determines whether the memory 18 is sufficient to store the plurality of data packets 36 generated by the computing devices 12 of the mesh network 14 (FIG. 4A, block 312). If the memory 18 is insufficient to store the plurality of data packets 36 (FIG. 4A, block 314), the computing device 12-1 notifies a third party (FIG. 4A, block 316) by, for instance, setting the interval notification flag 42-3 (FIG. 4A, block 318).

After setting the interval notification flag 42-3 (FIG. 4A, block 318) and/or if the memory 18 is sufficient to store the plurality of data packets 36 (FIG. 4A, block 320) and/or when the mesh configuration parameter is disabled (FIG. 4A, block 322), the computing device 12-1 determines whether to enter a collection window (FIG. 4A, block 324). If the computing device 12-1 determines not to enter the collection window (FIG. 4A, block 326), the computing device 12-1 obtains sensor data (e.g., via the sensors 22) and the plurality of data packets 36 from the computing devices 12-2 – 12-4 of the mesh network 14 (FIG. 4A, block 328).

If the computing device 12-1 determines to enter the collection window (FIG. 4A, block 330), the computing device 12-1 begins broadcasting advertisement data packets via the network interface 32 (FIG. 4A, block 332). If the computing device 12-1 receives an acknowledgement packet and/or a connection request from the computing device 50 in response to the advertisement data packet (FIG. 4A, block 334), the computing device 12-1 will initiate a handshake transaction with the computing device 50.

The computing device 12-1 determines whether the handshake transaction is successful (FIG. 4A, block 336). If the handshake transaction is unsuccessful (FIG. 4A, block 338), the computing device 12-1 will begin broadcasting advertisement data packets via the network interface 32 following the expiration of a reinitiation wait time (e.g., based on the reinitiation wait time identifier 42-9) (FIG. 4A, block 332).

If the handshake transaction is successful (FIG. 4A, block 340), the computing device 12-1 will begin providing the data payload 34 to the computing device 12-1 (FIG. 4A, block 342). If the data transmission is interrupted (FIG. 4A, block 344), the computing device 12-1 will discard the subset of packets 36 transmitted to the computing device 50 from the memory 18, notify the computing devices 12 of the mesh network 14, notify a third party, and/or the like (FIG. 4A, block 346). If the data transmission is successful (e.g., the data payload 34 is successfully provided to the computing device 50) (FIG. 4A, block 348), the communication link between the computing device 12-1 and the computing device 50 is terminated (FIG. 4A, block 350).

Referring now to FIG. 4B, the computing device 50 is configured based on the configuration file 76 (FIG. 4B, block 352). The computing device 50 begins listening for advertisement data packets (FIG. 4B, block 354) (e.g., sent by the first computing device 12-1 (FIG. 4A, block 332)). In response to receiving an advertisement data packet from the first computing device 12-1, the computing device 50 provides an acknowledgement packet (e.g., indicating the advertisement data packet was successfully received) and a connection request to the computing device 12-1 (FIG. 4B, block 356).

The computing device 50 determines whether the handshake transaction (e.g., with the computing device 12-1) is successful (FIG. 4B, block 358). If the handshake transaction is unsuccessful (FIG. 4B, block 360), the computing device 50 begins listening for advertisement data packets from the computing device 12-1 following the expiration of a reinitiation wait time (e.g., based on the reinitiation wait time identifier 80-8) (FIG. 4B, block 354). If the handshake transaction is successful (FIG. 4B, block 362), the computing device 50 establishes a communication link with the computing device 12-1 and obtains the data payload 34 from the computing device 12-1 (FIG. 4B, block 364).

The computing device 50 determines whether the data payload 34 has been successfully received (e.g., based on the transmission size threshold identifier 42-6 received from the computing device 12-1, the transmission size threshold identifier 80-5 of the configuration file 76, etc.) (FIG. 4B, block 366).

If the computing device 50 receives a subset of the plurality of data packets 36, and/or if the computing device 50 does not receive the transmission size threshold identifier 42-6 from the computing device 12-1, the computing device 50 determines the data payload 34 was not successfully received (FIG. 4B, block 368).

If the data payload 34 is successfully received (FIG. 4B, block 370), the communication link between the computing device 12-1 and the computing device 50 is terminated, and the computing device 50 determines whether to enrich the data payload 34 (FIG. 4B, block 372). If the computing device 50 determines not to enrich the data payload 34 (e.g., based on the enrichment identifier 80-12, etc.) (FIG. 4B, block 374), the computing device 50 stores the data payload 34 in the memory 54 (FIG. 4B, block 376).

If the computing device 50 determines to enrich the data payload 34 (e.g., based on the enrichment identifier 80-12, etc.) (FIG. 4B, block 378), the computing device 50 provides the data payload 34 to a machine-learning model 82 and generates an enriched data payload 34' based on an output of the machine-learning model 82 (FIG. 4B, block 380). The computing device 50 stores the enriched data payload 34' in the memory 54 (FIG. 4B, block 382).

The computing device 50 obtains geolocation data 62 via the navigation positioning system 60 and determines whether the computing device 50 is at a central location based on the geolocation data 62 (FIG. 4B, block 384). When the computing device 50 arrives at the central location (FIG. 4B, block 386), the computing device establishes a communication link (e.g., via network interface 86) with the remote computing system 88 (e.g., via the network 98) and provides the data payload 34 to the remote computing system 88 (e.g., via the network 98) (FIG. 4B, block 388). Subsequent to providing the data payload 34 to the remote computing system 88, the computing device 50 discards the data payload 34 from the memory of the computing device 50 (FIG. 4B, block 390).

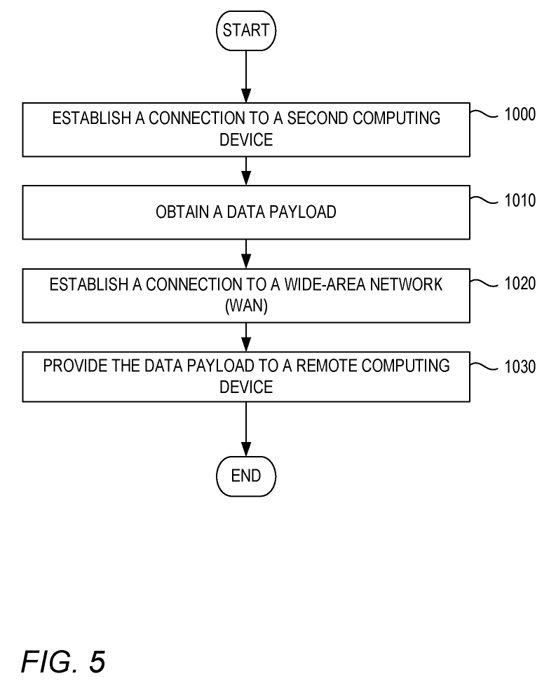

FIG. 5 depicts a flowchart of an example asynchronous data transmission method according to some implementations of the present disclosure. FIG. 5 will be discussed in conjunction with FIG. 1–2 . The computing device 50 (hereinafter, first computing device 50), which is at a first location (e.g., location 106), establishes a connection to the peripheral computing device 12-1 (hereinafter, second computing device 12-1) (FIG. 5, block 1000). The first computing device 50 obtains the data payload 34—which includes a plurality of data packets 36-1 – 36-N generated by the second computing device 12-1—from the second computing device 12-1 (FIG. 5, block 1010). The first computing device 50 establishes a connection to a wide area network (WAN) 98 at a second location (e.g., location 114) that is different from the first location (e.g., location 106) (FIG. 5, block 1020). The first computing device 50 provides the data payload 34 to a remote computing device, such as the remote computing system 88, via the WAN 98 (FIG. 5, block 1030).

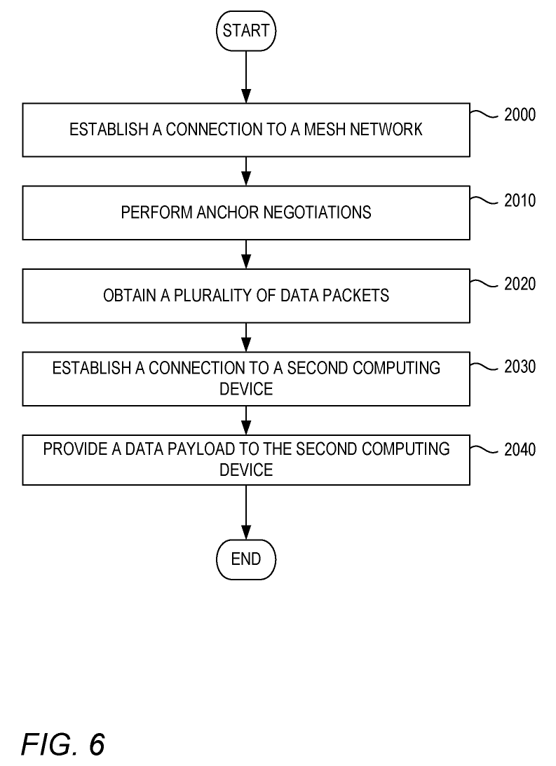

FIG. 6 depicts a flowchart of an example asynchronous data transmission method according to some implementations of the present disclosure. FIG. 6 will be discussed in conjunction with FIGS. 1-2. The computing device 12-1, which is at a first location (e.g., location 106), is configured based on the configuration file 38 and, subsequently, establishes a communication link to the computing devices 12-2 – 12-4 to form the mesh network 14 (FIG. 6, block 2000). The computing devices 12 of the mesh network 14 perform anchor negotiations to establish an anchor computing device (FIG. 6, block 2010). For purposes of illustration and discussion, the computing device 12-1 is established as the anchor computing device for the mesh network. The computing device 12-1 obtains a plurality of data packets 36 (e.g., generated by the computing devices 12 of the mesh network 14) (FIG. 6, block 2020). The computing device 12-1 enters a collection window, begins broadcasting advertisement data packets via the network interface 32, and establishes a connection to the computing device 50 (FIG. 6, block 2030). Subsequently, the computing device 12-1 provides a data payload 34 (e.g., plurality of data packets 36) to the computing device 50 to transmission to the remote computing system 88 (FIG. 6, block 2040).

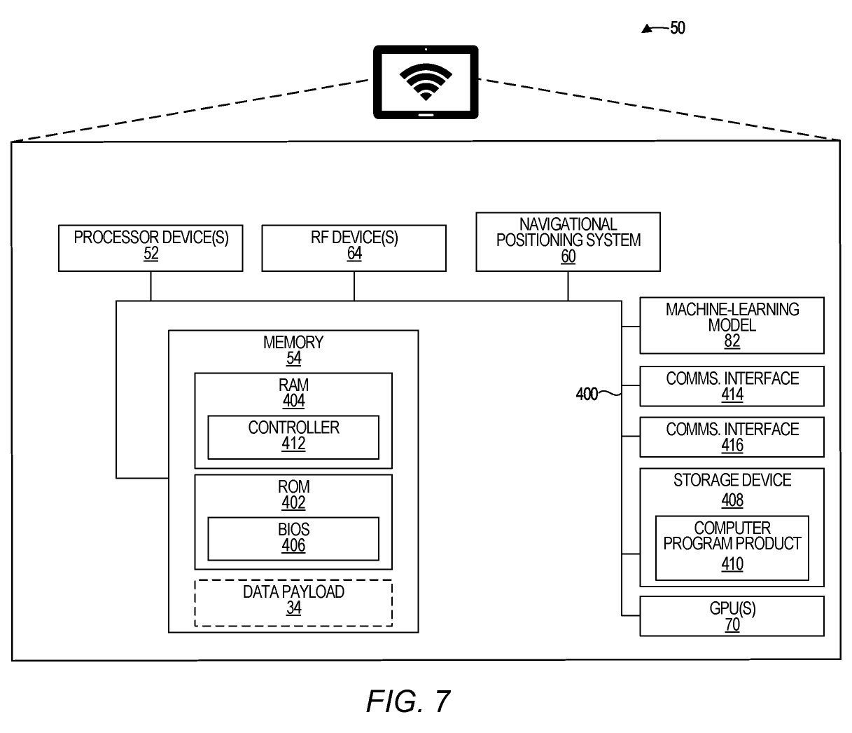

FIG. 7 depicts a block diagram of a collector computing device, such as the computing device 50, suitable for implementing examples disclosed herein according to some embodiments. The computing device 50 may be any suitable computing device operable to perform the asynchronous data transmission operations described herein.

The computing device 50 may include any computing and/or electronic device capable of including firmware, hardware, and/or executing software instructions to implement the functionality described herein, such as a computer server, computing device, and/or the like. The computing device 50 includes processor device(s) 52, a system memory (e.g., memory 54), and a system bus 400. The system bus 400 provides an interface for system components including, but not limited to, the memory 54 and the processor device 52. The processor device(s) 52 may be any commercially available or proprietary processor.

The system bus 400 may be any of several types of bus structures that may further interconnect to a memory bus (with or without a memory controller), a peripheral bus, and/or a local bus using any of a variety of commercially available bus architectures. The memory 54 may include non-volatile memory 402 (e.g., read-only memory (ROM), erasable programmable read-only memory (EPROM), electrically erasable programmable read-only memory (EEPROM), etc.), and volatile memory 404 (e.g., random-access memory (RAM)). A basic input/output system (BIOS) 406 may be stored in the non-volatile memory 402 and may include the basic routines that help to transfer information between elements within the computing device 50. The volatile memory 404 may also include a high-speed RAM, such as static RAM, for caching data.

The computing device 50 may further include or be coupled to a non-transitory computer-readable storage medium, such as a storage device 408, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 408 and other drives associated with computer-readable media and computer-usable media may provide non-volatile storage of data, data structures, computer-executable instructions, and the like.

A number of modules can be stored in the storage device 408 and in the volatile memory 404, including an operating system and one or more program modules, which may implement the functionality described herein in whole or in part. All or a portion of the examples may be implemented as a computer program product 410 stored on a transitory or non-transitory computer-usable or computer-readable storage medium, such as the storage device 408, which includes complex programming instructions, such as complex computer-readable program code, to cause the processor device 52 to carry out the steps described herein. Thus, the computer-readable program code may comprise software instructions for implementing the functionality of the examples described herein when executed on the processor device 52. The processor device 52, in conjunction with a controller 412 in the volatile memory 404, may serve as a controller and/or or a control system for the computing device 50 that is to implement the functionality described herein.

An operator (e.g., user) may also be able to enter one or more configuration commands through a keyboard (not illustrated), a pointing device such as a mouse (not illustrated), or a touch-sensitive surface such as a display device (e.g., display device 72). Such input devices may be connected to the processor device 52 through the input interface 66 coupled to the system bus 400 but can be connected through other interfaces such as a parallel port, an Institute of Electrical and Electronic Engineers (IEEE) 1394 serial port, a Universal Serial Bus (USB) port, an IR interface, and/or the like.

The computing device 50 may also include a number of communication interfaces, such as communication interface 414 and/or communication interface 416, that are suitable for communicating with a network (or devices connected thereto) as appropriate or desired. For instance, the computing device 50 may establish a communication link with the network 30 via communication interface 414 (e.g., network interface 74). The computing device 50 may also establish a communication link with the network 98 via communication interface 416 (e.g., network interface 86). The computing device 50 may further include one or more GPUs 70.

The computing device 50 may further include one or more radio frequency (RF) devices 64. In some examples, the computing device 50 may be operable to receive the data payload 34 and/or an RF tag (not shown) from the computing devices 12 of the mesh network 14 via the RF device(s) 64. The computing device 50 may further include the navigation positioning system 60, which is operable to obtain geolocation data 62 associated with a physical location of the computing device 50.

In some examples, the computing device 50 may further include the machine-learning model 82. Although not depicted as such in Figure 7, the machine-learning model 82 may be stored in the memory 54, the storage device 408, and/or the like. The computing device 50 may be configured to generate an enriched data payload 34' (not shown) and/or a plurality of data insights 84 (not shown) based on an output of the machine-learning model 82. The machine-learning model 82 may be any suitable machine-learning model, such as, by way of non-limiting example, a neural network (e.g., deep neural network, feed-forward neural network, recurrent neural network, convolutional neural network, etc.) and/or other types of machine-learning models (e.g., non-linear models, linear models, etc.). In some examples, the machine-learning model 82 may be trained using an unsupervised training algorithm (not shown) (e.g., K-means, hierarchical clustering, etc.) to refine the machine-learning model 82 and its corresponding outputs.

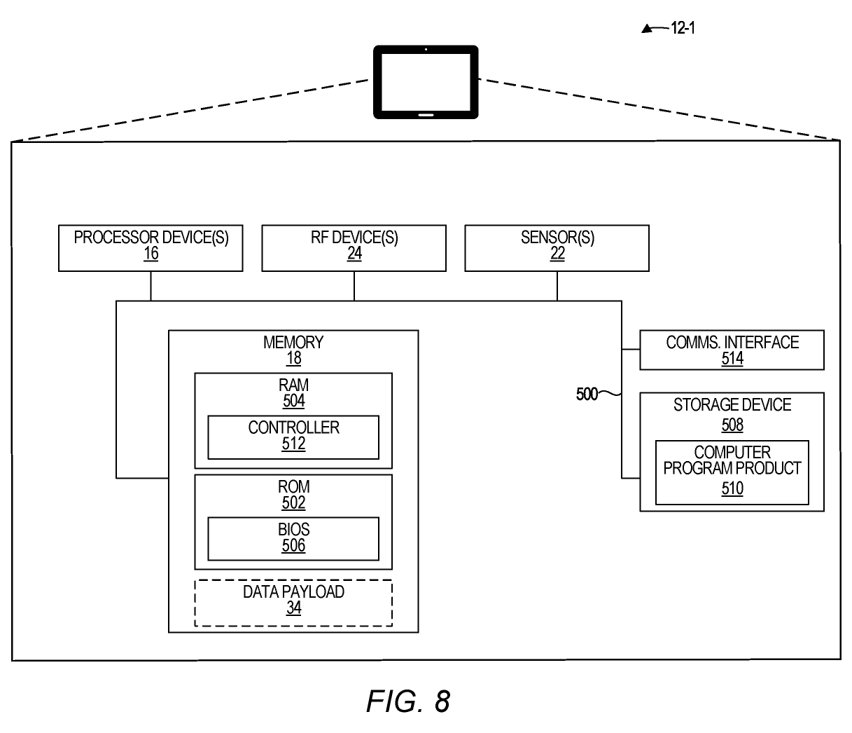

FIG. 8 depicts a block diagram of a peripheral computing device, such as the computing device 12-1, suitable for implementing examples disclosed herein according to some embodiments. The computing device 12-1 may be any suitable computing device operable to perform the asynchronous data transmission operations described herein.

The computing device 12-1 may include any computing and/or electronic device capable of including firmware, hardware, and/or executing software instructions to implement the functionality described herein, such as a computer server, computing device, and/or the like. The computing device 12-1 includes processor device(s) 16, a system memory (e.g., memory 18), and a system bus 500. The system bus 500 provides an interface for system components including, but not limited to, the memory 18 and the processor device 16. The processor device(s) 16 may be any commercially available or proprietary processor.

The system bus 500 may be any of several types of bus structures that may further interconnect to a memory bus (with or without a memory controller), a peripheral bus, and/or a local bus using any of a variety of commercially available bus architectures. The memory 18 may include non-volatile memory 502 (e.g., read-only memory (ROM), erasable programmable read-only memory (EPROM), electrically erasable programmable read-only memory (EEPROM), etc.), and volatile memory 504 (e.g., random-access memory (RAM)). A basic input/output system (BIOS) 506 may be stored in the non-volatile memory 502 and may include the basic routines that help to transfer information between elements within the computing device 12-1. The volatile memory 504 may also include a high-speed RAM, such as static RAM, for caching data.

The computing device 12-1 may further include or be coupled to a non-transitory computer-readable storage medium, such as a storage device 508, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 508 and other drives associated with computer-readable media and computer-usable media may provide non-volatile storage of data, data structures, computer-executable instructions, and the like.

A number of modules can be stored in the storage device 508 and in the volatile memory 504, including an operating system and one or more program modules, which may implement the functionality described herein in whole or in part. All or a portion of the examples may be implemented as a computer program product 510 stored on a transitory or non-transitory computer-usable or computer-readable storage medium, such as the storage device 508, which includes complex programming instructions, such as complex computer-readable program code, to cause the processor device 16 to carry out the steps described herein. Thus, the computer-readable program code may comprise software instructions for implementing the functionality of the examples described herein when executed on the processor device 16. The processor device 16, in conjunction with a controller 512 in the volatile memory 504, may serve as a controller and/or or a control system for the computing device 12-1 that is to implement the functionality described herein.

An operator (e.g., user) may also be able to enter one or more configuration commands through a keyboard (not illustrated), a pointing device such as a mouse (not illustrated), or a touch-sensitive surface such as a display device (not illustrated). Such input devices may be connected to the processor device 16 through the input interface 26 coupled to the system bus 500 but can be connected through other interfaces such as a parallel port, an Institute of Electrical and Electronic Engineers (IEEE) 1394 serial port, a Universal Serial Bus (USB) port, an IR interface, and/or the like.

The computing device 12-1 may also include a number of communication interfaces, such as communication interface 514, that are suitable for communicating with a network (or devices connected thereto) as appropriate or desired. For instance, the computing device 12-1 may establish a communication link with the network 30 via communication interface 514 (e.g., network interface 32). The computing device 50 may also establish a communication link with the mesh network 14 via communication interface 414 (e.g., network interface 32).

The computing device 12-1 may further include one or more radio frequency (RF) devices 24. In some examples, the computing device 12-1 may be operable to receive the data payload 34 (e.g., data packets 36) from the computing devices 12 of the mesh network 14 via the RF device 24. In some examples, the computing device 12-1 may be operable to provide the data payload 34 and/or an RF tag (not shown) to the computing device 50 via the RF device 24.

Individuals will recognize improvements and modifications to the preferred examples of the disclosure. All such improvements and modifications are considered within the scope of the concepts disclosed herein and the claims that follow.

What is claimed is:

1. A method, comprising:
establishing, by a first computing device at a first location, a connection to a second computing device;
obtaining, by the first computing device from the second computing device, a data payload, the data payload comprising a plurality of data packets generated by the second computing device;
establishing, by the first computing device at a second location that is different from the first location, a connection to a wide area network (WAN); and
providing, by the first computing device via the WAN, the data payload to a remote computing device.

2. The method of claim 1, wherein establishing the connection to the second computing device comprises:
receiving, by the first computing device from the second computing device, an advertisement data packet;
in response to receiving the advertisement data packet, providing, by the first computing device to the second computing device, an acknowledgement packet indicating the advertisement data packet was successfully received; and
subsequent to providing the acknowledgement packet, establishing, by the first computing device, the connection to the second computing device.

3. The method of claim 1, wherein obtaining the data payload comprises:
receiving, by the first computing device from the second computing device, a subset of the plurality of data packets;
determining, by the first computing device, that the subset of the plurality of data packets does not include data indicative of a transmission size threshold;
in response to determining that the subset of the plurality of data packets does not include the data indicative of the transmission size threshold, providing, by the first computing device to the second computing device, data indicating that the data payload was not successfully received; and
terminating, by the first computing device, the connection to the second computing device.

4. The method of claim 3, further comprising:
subsequent to terminating the connection to the second computing device, determining, by the first computing device, a reinitiation wait time based on a configuration file stored in a memory of the first computing device;
determining, by the first computing device, that the reinitiation wait time has elapsed; and
subsequent to determining that the reinitiation wait time has elapsed, reestablishing, by the first computing device, the connection to the second computing device.

5. The method of claim 1, wherein obtaining the data payload comprises:
receiving, by the first computing device from the second computing device, the plurality of data packets, at least one data packet of the plurality of data packets comprising data indicative of a transmission size threshold;
determining, by the first computing device, that a size of the data payload matches the transmission size threshold;
responsive to determining that the size of the data payload matches the transmission size threshold, providing, by the first computing device to the second computing device, data indicating that the data payload was successfully received;
terminating, by the first computing device, the connection to the second computing device; and
storing, by the first computing device, the data payload in a memory of the first computing device.

6. The method of claim 5, wherein at least one data packet of the plurality of data packets comprises a service provider identifier associated with the second computing device, and wherein providing the data payload to the remote computing device comprises:
determining, by the first computing device, a remote computing system based on the service provider identifier associated with the second computing device, the remote computing system comprising the remote computing device;
providing, by the first computing device, the data payload to a database of the remote computing system; and
subsequent to providing the data payload to the database of the remote computing system, discarding, by the first computing device, the data payload from the memory of the first computing device.

7. The method of claim 5, wherein a configuration file stored in the memory of the first computing device comprises a data enrichment identifier, the method further comprising:
subsequent to determining that the size of the data payload matches the transmission size threshold, enriching, by the first computing device, the data payload based on the data enrichment identifier; and
responsive to enriching the data payload, storing, by the first computing device, the data payload in the memory of the first computing device.

8. The method of claim 7, wherein enriching the data payload comprises:
providing, by the first computing device, the data payload to a machine-learning model stored in the memory of the first computing device;
generating, by the first computing device, an enriched data payload based on an output of the machine-learning model; and
storing, by the first computing device, the enriched data payload in the memory of the first computing device.

9. The method of claim 8, further comprising:
determining, by the first computing device, a plurality of data insights associated with the enriched data payload based on the output of the machine-learning model; and
providing, by the first computing device to a display device, the plurality of data insights for display to a user.

10. The method of claim 1, wherein the second computing device is an anchor computing device of a mesh network, the mesh network comprising a plurality of second computing devices.

11. The method of claim 10, wherein the plurality of data packets of the data payload are respectively generated by at least one of the plurality of second computing devices.

12. The method of claim 11, wherein each second computing device of the plurality of second computing devices of the mesh network is configured to provide data to the first computing device via the anchor computing device.

13. The method of claim 1, wherein establishing the connection to the second computing device comprises:
establishing, by the first computing device at the first location, a first communication link with the second computing device, the first communication link corresponding to a wireless personal area network (PAN).

14. The method of claim 13, wherein the first communication link comprises a Bluetooth Low Energy (BLE) protocol.

15. The method of claim 13, wherein the first computing device comprises a navigation positioning system operable to generate geolocation data corresponding to a location of the first computing device, and wherein establishing the connection to the WAN comprises:
determining, by the first computing device, that the first computing device is at the second location based on the geolocation data generated by the navigation positioning system; and
responsive to determining that the first computing device is at the second location, establishing, by the first computing device, a second communication link, the second communication link corresponding to the WAN.

16. The method of claim 15, wherein the second communication link is unavailable at the first location.

17. A collector computing device, comprising:
a memory; and
a processor device coupled to the memory and operable to:
establish, at a first location, a connection to a peripheral computing device;
obtain, from the peripheral computing device, a data payload, the data payload comprising a plurality of data packets generated by the peripheral computing device;
establish, at a second location that is different from the first location, a connection to a wide area network (WAN); and
provide, via the WAN, the data payload to a remote computing device.

18. The collector computing device of claim 17, further comprising:
a navigation positioning system operable to generate geolocation data corresponding to a location of the collector computing device,
wherein, to establish the connection to the WAN, the processor device is operable to:
obtain, via the navigation positioning system, the geolocation data corresponding to the location of the collector computing device;
determine, based on the geolocation data, that the collector computing device is at the second location; and
responsive to determining that the collector computing device is at the second location, establish the connection to the WAN.

19. The collector computing device of claim 17, wherein:
to obtain the data payload, the processor device is operable to:
receive, from the peripheral computing device, the plurality of data packets, at least one data packet of the plurality of data packets comprising data indicative of a transmission size threshold, at least one data packet of the plurality of data packets comprising a service provider identifier associated with the peripheral computing device;
determine that a size of the data payload matches the transmission size threshold;
responsive to determining that the size of the data payload matches the transmission size threshold, provide, to the peripheral computing device, data indicating that the data payload was successfully received;
terminate the connection to the peripheral computing device; and
store the data payload in the memory; and
to provide the data payload to the remote computing device, the processor device is operable to:
determine a remote computing system based on the service provider identifier associated with the peripheral computing device, the remote computing system comprising the remote computing device;
provide the data payload to a database of the remote computing system; and
subsequent to providing the data payload to the database of the remote computing system, discard the data payload from the memory.

20. A non-transitory computer-readable medium that includes executable instructions configured to cause a processor device of a first computing device to:
establish, at a first location, a connection to a second computing device;
obtain, from the second computing device, a data payload, the data payload comprising a plurality of data packets generated by the second computing device;
establish, at a second location that is different from the first location, a connection to a wide area network (WAN); and
provide, via the WAN, the data payload to a remote computing device.
